(19) United States
(12) Patent Application Publication
(10) Pub. No.: US 2010/0056112 A1
(43) Pub. Date: Mar. 4, 2010

(54) METHOD AND SYSTEM FOR AUTOMATICALLY MANAGING NOTIFICATIONS IN HETEROGENOUS FORMATS

(75) Inventors: Marie-Pascale Dupont, Nozay (FR); Stéphane Betge-Brezetz, Nozay (FR); Guy-Bertrand Kamga, Nozay (FR); Sophie Piekarec, Nozay (FR); Arnaud Vergnol, Colombes (FR)

Correspondence Address: FAY SHARPE/LUCENT, 1228 Euclid Avenue, 5th Floor, The Halle Building, Cleveland, OH, 44115-1843, US

(73) Assignee: Alcatel-Lucent via the Electronic Patent Assignemt System (EPAS)

(21) Appl. No.: 12/549,088

(22) Filed: Aug. 27, 2009

(30) Foreign Application Priority Data
Aug. 29, 2008 (FR) 0804777

(51) Int. Cl. H04L 12/58

(52) U.S. Cl. 455/412.2; 340/539.11; 455/466

(57) ABSTRACT

A method for automatically managing user notifications in heterogeneous formats within a mobile terminal (10) capable of receiving or generating, as well as displaying, these notifications, which method comprises the following steps:
translating each notification received or generated by the mobile terminal into metadata in a single format,
saving said translation within a database (2),
assessing the priority of said notification based on a combination of priority criteria preset by the user,
reorganizing the database (2) containing said notification, based on its priority compared with other translated notifications that have already been saved,
displaying the notification on the terminal (10) based on its priority.

This invention pertains to the technical field of telecommunications. Its objects are a method and a system for automatically managing notifications received by a mobile terminal.

In particular, it pertains to user notifications transmitted by various services and various applications, addressed to the user of a mobile telephone. As a nonlimiting example, they may particularly include notifications in the form of short SMS (Short Message Service) or MMS (Multimedia Message Service) messages; or notifications sent by an application within the mobile terminal and configured to send and/or receive e-mail, notifying the user of the arrival of a new text or voice message or a missed call, a calendar memo, an information memo or alert from a local network, a confirmation/request of a certain task (reloading an account, subscribing to a service), etc.

These notifications may be interactive, or request the sending of certain information, or be informative (for example, in the form of an alert or a reminder to perform a certain task). Furthermore, they are generally volatile in nature, and, for the user of a mobile terminal, may be of different levels of importance or urgency.

However, the techniques currently in use have the drawback of not supporting any automatic management of notifications of different types. Thus, when simultaneously receiving multiple notifications, the user of the mobile terminal is required to check all of the notifications in succession, even though he does not know their degree of priority beforehand, as this can only be determined after having viewed the content of the notification. This may require a great deal of time, and delay decision-making. Additionally, the user must be able to reliably access the notifications. Otherwise, he might accidentally erase or lose one or more of the simultaneously received notifications.

Few methods and systems are known for managing user notifications. Furthermore, these systems are very specific. They primarily deal with a few special alerts without making it possible to handle different types of notifications in a unified manner.

The document U.S. Pat. No. 6,396,513, for example, describes a system for sorting incoming mail based on criteria preset by the inbox's user.

The solution Visual Voice Mail, recently introduced by Verizon Wireless and produced by Alcatel-Lucent and Comverse, is devoted to the management of voice messages. It makes it possible to display the list of voice messages received by a mobile terminal in an interactive graphical interface without any prior configuration of priority rules.

The document U.S. Pat. No. 7,359,936 describes a mail agent system which makes it possible to categorize mail entering an inbox. This categorization is based on a preview of the incoming mail, which comprises the mail's basic identifiers (sender, date, subject, size, etc.) and a set of keywords obtained from a word count of the mail's contents. This latter function may be implemented using products on the market, such as Intelligent Miner for Text, produced by the IBM Corporation. As a result of the categorization, a graphical interface system makes it possible to present the items based on options preset by the inbox's user.

It has been observed that notifications intended for mobile terminals are becoming increasingly frequent. Furthermore, they arrive at the terminal via a heterogeneous range of channels and services: telephone messaging services (SMS/MMS: advertising notifications, service notifications, telephone provider notifications, etc.), geolocation services, e-mail services, services incorporated into the mobile terminal (calendar, reminders, etc.), a notification service supported by a WLAN (Wireless Local Area Network) of a particular environment (a hospital's WLAN: medical staff alerts; a transportation service WLAN: notifications for travelers; a shopping center's WLAN: notifications for customers, etc.).

Known systems and methods are imperfect, particularly due to the absence of a way to comprehensively manage all of the notifications received by the mobile terminal that would enable the user to homogenize and then intelligently organize these notifications based on importance and urgency criteria which may be customizable.

One object of the present invention is to remedy the aforementioned drawbacks. In particular, the invention aims to disclose a universal method and system for the management (particularly receiving, saving, and checking) of user notifications received by a mobile terminal, regardless of their source or origin.

To that end, the invention, according to a first aspect, discloses a method for automatically managing user notifications in heterogeneous formats within a mobile terminal capable of receiving or generating, as well as displaying, these notifications, which method comprises the following steps:
translating each notification received or generated by the mobile terminal into a single metadata format,
saving said translation within a database,
assessing the priority of said notification based on priority criteria preset by the user,
reorganizing the database containing said notification, based on its priority compared with other translated notifications that have already been saved,
displaying the notification on the terminal based on its priority.

According to a second aspect, the invention discloses a system for automatically managing user notifications in heterogeneous formats within a mobile terminal capable of receiving or generating, as well as displaying, these notifications, said system comprising:
a notification reception module, capable of translating each notification received or generated by said mobile terminal into metadata in a single format,
a database for saving the translations,
a module for assessing the priority of each notification based on priority criteria preset by the user,
a module for organizing the database based on the respective priorities of the notifications saved therein,
an interactive graphical module for displaying notifications based on their priorities.

The invention enables the intelligent, automatic management of notifications received by a mobile terminal, independent of the source and format of the notifications. In particular, it makes it possible to better define the priorities of each notification compared with the others, by using criteria set by the mobile terminal's user. By way of a nonlimiting example, the priority criteria may be selected from among: the notification's importance, its source, its urgency, its life span, how frequently it appears, its content, etc.

Furthermore, the invention enables an intelligent combination of the rules and profile of the mobile terminal's user in order to compute the notifications' priorities.

The invention may particularly be applied to environments in which the mobile terminal frequently requests its user's attention.

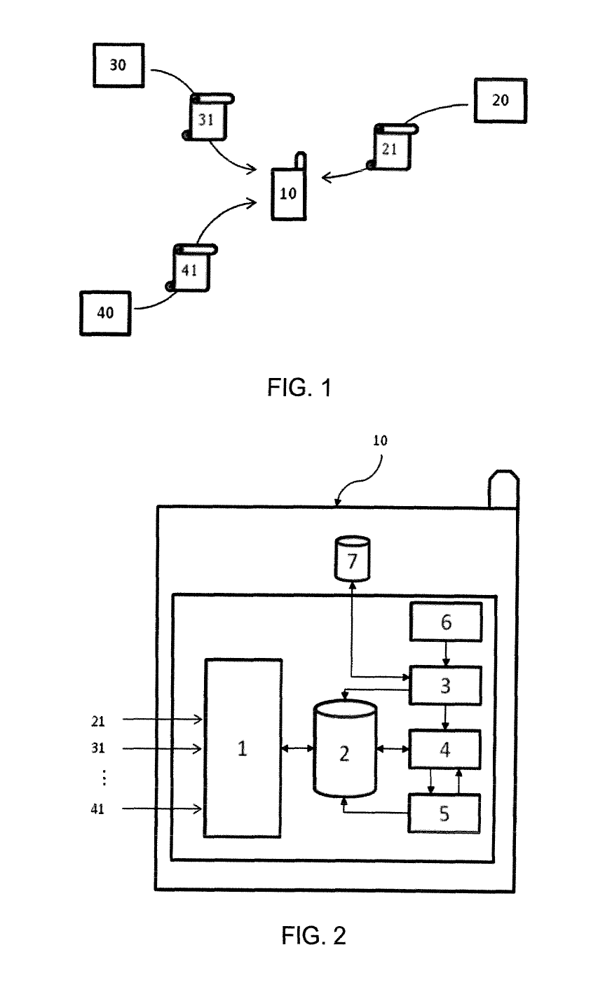

Other characteristics and benefits of the invention will become more clearly and fully apparent upon reading the description below of a preferred variant implementation of the method and embodiment of the system, with reference to the attached drawings, in which:
FIG. 1 schematically depicts the application context of the invention,
FIG. 2 is a diagram illustrating the various steps of the inventive method, while showing the relationships between the various modules of the system.

In this description of the method and system for automatically managing user notifications, it is assumed that a mobile terminal 10 is simultaneously receiving multiple notifications 21, 31, and 41 sent by various sources 20, 30 and 40. By way of a nonlimiting example, these notifications may be a call notification, an e-mail notification, a calendar notification, etc. These notifications may be (and generally are) in heterogeneous formats.

The automatic management of notifications is ensured by the functional modules, which, in the nonlimiting example depicted in FIG. 2, are embedded in the mobile terminal 10. One implementation of at least some of these modules could be embodied within senders 20, 30 and 40.

These modules comprise:
A module 1 for receiving user notifications sent by the various sources 20, 30, 40. By way of example, the use of proxy servers makes it possible to create an interface with various types of sending applications and platforms. Another function of the module 1 is to homogenize the format of the various user notifications for the purpose of processing them together later, the user notifications being translated into a single internal metadata format, which may be understood by the other modules described below. The translation of the user notification comprises the following operations:
   identifying information about said notification's source service,
   identifying fields within said notification,
   identifying the notification's descriptive characteristics,
   completing the metadata corresponding to said notification by means of the information about the source service, by means of the identified fields, and by means of the descriptive characteristics.
A database 2 used as a medium for centralizing the notifications which are conveyed to it by the reception module 1. This database 2 gathers the newly received user notifications 21, 31 and 41, as well as the log of notifications accompanied by the details concerning them, such as: their priority levels, senders, lifespan, reception dates, etc.
A priority management module 3, configured to apply priority criteria to the metadata about the user notifications centralized within the database 2. By convention, it is assumed that these criteria are time-dependent (an urgency criterion). Consequently, module 3 performs a regular reassessment of the notifications' priority levels, and manages the notifications which are thereby continuously updated.
A module 4 configured to ensure the ordering of the metadata regarding the user notifications based on the results obtained by the priority management module 3. The module 4 arranges the metadata regarding the user notifications continuously at the same frequency as the management of priorities by the corresponding module 3, which makes it possible to eventually trigger the reminders corresponding to time-delayed notifications.
A display management module 5, configured to control the displaying of user notifications triggered by the module 4. The module 5 controls an interactive user interface, which enables this interface to modify or input data. The interface also serves to display the log of notifications in the order defined by the module 4, or any other order chosen by the mobile terminal's user. By way of example, the user may display notifications classified based on their date of reception, their sender, etc.
An advanced configuration module 6 of the priority manager 3. This module 6 is equipped with a graphical user interface which enables the mobile terminal's user to input or edit the priority criteria used afterward by the priority management module 3.

The priority manager 3 may also be configured to take into account personal criteria, implemented within a profile database 7, such as the user's profile, which may advantageously be editable or even deletable. Furthermore, multiple user profiles may be implemented within the database 7.

Preferentially, the module 6 is further configured to:
define multiple priority levels. In this manner, the urgency criterion may comprise three levels of time, such as: immediate; before a given time; before a given date. Likewise, the urgency criteria may comprise three levels of importance, such as; crucial; important; informative.
take into account keywords (which may be expanded using a dictionary of synonyms), to be searched for within the content of the user notifications,
selects priority rules dealing with the identifiers and the characteristics of the user notifications. Thus, these rules may, for example, deal with the size of the notification, the date it was received, its attachments, the sending platform, the sender's identity, the subject, etc.

Preferentially, the user must also be able to directly edit the priority of a notification by using the interface of the priority manager 5.

In particular, the mobile terminal's user must be able to customize the notifications' priority criteria, even if these notifications already have their own priority levels.

The priority manager 3 identifies the priority criteria as defined in the configuration module 6 and the user profile selected in the database 7. Next, it calculates the priority levels of the new notifications stored in the database 2. The notifications are then ranked by order of priority using the module 4, which uses the results of the calculation performed by the priority manager 3. A reorganization of the content of the database 2 is also possible using the display's management module 5.

As mentioned above, the user notifications may come from external servers configured to communicate with the mobile terminal 10, or be generated internally by it.

Furthermore, the notifications may or may not have preset priority levels, with or without time delays. These priority levels may be customized in association with a user profile and priority criteria that may be configured using the advanced configuration module 6

Preferentially, the metadata's internal format may be extended to any other new information available regarding a user notification.

An automatic management of user notifications, for example 21, 31, and 41, within the mobile terminal 10 capable of receiving or generating, as well as displaying, said notifications, comprises at least the following steps:
translating each notification received or generated by the mobile terminal into a single metadata format,
saving said translation within a database 2,
assessing the priority of said notification based on priority criteria preset by the user,
reorganizing the database 2 containing said notification, based on its priority compared with other translated notifications that have already been saved,
displaying the notification on the terminal based on its priority.

The reorganization of the database comprises comparing the notification's priority with the priorities of the other notifications coming from:
the same service as that notification;
or a different service.

Example 1 below depicts an alert notification. Example 2 depicts the possible translation of this notification into a metadata format that may be used to save the translations.

### EXAMPLE 1

<Alert>
<Sender> Patient Monitoring System </Sender>
<Type> Abnormal situation</Type>
<ActivityDomain> Health </ActivityDomain>
<Msg> Fall Detection in Room 21, Emergency Department </Msg>
<Time> 12:32 AM </Time>
<ThirdParty> Bob Smith </ThirdParty>
<Priority> High </Priority>
<AckRequired> Yes </AckRequired>
<AckTimeout> 20 </AckTimeout>
<TimeToLive> 60 </TimeToLive>

</Alert>

### EXAMPLE 2

<NotifEvent>
<Sender> Patient Monitoring System </Sender>
<Type> Abnormal situation</Type>
<ActivityDomain> Health </ActivityDomain>
<Content>
   <Title> </Title>
   <Msg> Fall Detection in Room 21</Msg>
   <MoreInfo></MoreInfo>
   <Keywords> Emergency, Fall </Keywords>
   <Attachments> </Attachments>
</Content>
<ThirdParty> Bob Smith </ThirdParty>
<Priority> 8 </Priority>
<ReceptionTime> 12:32:50 </ReceptionTime>
<AckRequired> Yes </AckRequired>
<AckTimeout> 20 </AckTimeout>
<NbRepetition> 2 </NbRepetition>
<TimeToLive> 60 </TimeToLive>
<Status> Not Treated </Status>
<AdditionalInfo> </AdditionalInfo>

</NotifEvent>

Let us assume that the priority levels range from 1 (low priority) to 10 (highest priority). A functional, nonlimiting calculation of priority level 8, with reference to the two aforementioned examples, takes into account at least:
the priority of the incoming alert, here high;
the sender, here Patient Monitoring System;
the abnormal medical situation
the request for acknowledgment;
keywords, here Emergency and Fall;
the number of times the alert was received without being checked.

1. A method for automatically managing user notifications in heterogeneous formats within a mobile terminal (10) capable of receiving or generating, as well as displaying, these notifications, wherein it comprises the following steps:
translating each notification received or generated by the mobile terminal into metadata in a single format,
saving said translation within a database (2),
assessing the priority of said notification based on a combination of priority criteria preset by the user and the notification's content,
reorganizing the database (2) containing said notification, based on its priority compared with other translated notifications that have already been saved,
displaying the notification on the terminal (10) based on its priority.

2. A method according to claim 1, wherein the priority criteria are based on at least one profile of the mobile terminal's user.

3. A method according to claim 1, wherein the step of translating the notification comprises the following operations:
identifying information about said notification's source service,
identifying fields within said notification,
identifying the notification's descriptive characteristics,
completing the metadata corresponding to said notification by means of the information about the source service, by means of the identified fields, and by means of the descriptive characteristics.

4. A method according to claim 3, wherein the priority criteria related to notification are a function of the information about the source service, the fields, and the notification's descriptive characteristics.

5. A method according to claim 1, wherein the assessment of the notification's priority comprises an operation of searching for keywords from a predefined list in the notification's content and potentially its attachments.

6. A method according to claim 5, wherein said search is expanded by means of synonyms of the keywords, identified in a dictionary of synonyms, abbreviations, and numbers.

7. A method according to claim 1, wherein the step of reorganizing the database comprises comparing the notification's priority with the priorities of the other notifications coming from the same service as that notification.

8. A method according to claim 5, wherein the step of reorganizing the database comprises comparing the notification's priority with the priorities of the other notifications coming from a different service than that notification's.

9. A system for managing user notifications in heterogeneous formats within a mobile terminal capable of receiving or generating and displaying these notifications, wherein it comprises:
a notification reception module (1), capable of translating each notification received or generated by said mobile terminal into metadata in a single format,
a database (2) for saving the translations,
a module (3) for assessing the priority (3) of each notification based on priority criteria preset by the user and on the notification's content,
a module (4) for organizing database (2) based on the respective priorities of the notifications saved therein,
an interactive graphical module (5) for displaying notifications based on their priorities.

10. A system according to claim 9, further comprising a module for configuring the priority criteria of the user notifications.
